(19) United States
(12) Patent Application Publication
(10) Pub. No.: US 2007/0140715 A1
(43) Pub. Date: Jun. 21, 2007

(54) Method of controlling driving of developing roller in image forming apparatus

(75) Inventor: Deug-hyun Choi, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/593,574

(22) Filed: Nov. 7, 2006

(30) Foreign Application Priority Data
Dec. 17, 2005 (KR) 2005-124915

(51) Int. Cl. G03G 15/08

(52) U.S. Cl. 399/53

(57) ABSTRACT

A method to control the driving of a developing roller includes controlling a driving stop point of the developing roller which is independently driven, wherein the driving stop point of the developing roller is determined by adding the print medium feed time from a virtual print medium start point to a virtual image end point and the time a photosensitive drum takes to rotate from an exposure point to a developing point on the photosensitive drum, so that the developing roller is driven only for the time during which an electrostatic latent image is developed.

### CROSS-REFERENCE TO RELATED APPLICATION

This application claims the benefit of Korean Application No. 2005-124915, filed Dec. 17, 2005, in the Korean Intellectual Property Office, the disclosure of which is incorporated herein by reference.

### BACKGROUND OF THE INVENTION

1. Field of the Invention

Aspects of the present invention relate to an image forming apparatus, and more particularly, to a method of controlling the driving of a developing roller to minimize the period of time during which the developing roller is driven during printing operations.

2. Description of the Related Art

Generally, an electro-photosensitive image forming apparatus forms a desired image onto a print medium by forming an electrostatic latent image corresponding to the desired image onto a photosensitive medium using an exposure apparatus, developing the electrostatic latent image using toner, transferring the developed image to a print medium, and fixing the image to the print medium by applying heat and pressure to the print medium. The print medium may be paper, transparency sheets, etc. An electro-photosensitive image forming apparatus generally includes a developing unit which stores toner. An electrostatic latent image is formed on a photosensitive medium. A developing roller develops the electrostatic latent image into a toner image. A supply roller supplies toner to the developing roller. The developing unit is detachable from the image forming apparatus, so that an old developing unit can be replaced with a new developing unit when the toner in the old developing unit runs out.

Usually, one of the following two methods is used to drive the developing unit during printing operations. In a first method, the photosensitive medium, the developing roller, and the supply roller are simultaneously driven using one motor. In a second method, the developing roller is driven independently from the photosensitive medium and supply roller by a clutch or a motor separate from a motor used to drive the photosensitive medium and other components.

In the first method, the driving of the developing roller stops at the time when the bottom edge of the print medium passes a discharging roller, as the print medium is discharged from the image forming apparatus into a discharge tray. Since this first method only uses one motor to drive the image forming apparatus, the printing operation according to the first method finishes when the print medium on which an image is formed completely passes over the discharging roller, at which point the image forming apparatus ceases printing operations.

In the second method, the developing roller and the transfer roller are sequentially arranged in the direction in which a photosensitive drum rotates. The developing roller develops the electrostatic latent image formed onto the photosensitive drum while the photosensitive drum rotates opposite the developing roller. Then, the developed image is transferred to the print medium while the photosensitive drum rotates opposite the transfer roller. The development of the electrostatic latent image finishes once the last portion of the image is transferred to the developing roller. At this point it is not necessary to drive the developing roller anymore. However, since the developed image has not yet been transferred to the print medium via the transfer roller, the print medium continues moving from the developing roller to the transfer roller for a period of time.

The first method is disadvantageous because the developing roller is unnecessarily driven during the entire period of time from when the electrostatic latent image is developed to when the print medium is discharged.

In the second method, the developing roller is not driven unnecessarily for as long a period of time as the developing roller is driven unnecessarily in the first method. However, in everyday printing operations, the image printed onto the print medium is typically not printed onto the entire print medium, because the image is typically not printed onto margin areas and/or other non-image areas of the print medium. Nevertheless, the developing roller is still unnecessarily driven for the period of time during which the margin portions, where no image is formed onto the print medium, are moved past the developing roller. Such an unnecessary operation of the developing roller leads to an excess buildup of toner which forms a thick film onto the surface of the developing roller. This unnecessary operation of the developing roller also wears down the cleaning blade that controls the thickness of the toner film adhering to the developing roller, and deteriorates the durability of toner.

### SUMMARY OF THE INVENTION

Aspects of the present invention provide a method to control the driving of a developing roller in an image forming apparatus, by which the time during which the developing roller is driven is minimized, since the developing roller is driven only when an electrostatic latent image is being developed, thereby increasing the lifetime and the reliability of the developing roller. Additional aspects and/or advantages of the invention will be set forth in part in the description which follows and, in part, will be obvious from the description, or may be learned by practice of the invention.

According to an aspect of the present invention, a method to control the driving of a developing roller includes controlling a driving stop point of the developing roller, wherein the driving stop point of the developing roller is determined by adding a print medium feed time from a virtual print medium start point to a virtual image end point and a time that a photosensitive drum takes to rotate from an exposure point to a developing point on the photosensitive drum, so that the developing roller is driven only when an electrostatic latent image is developed.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic side-sectional view illustrating the structure of an image forming apparatus according to an aspect of the present invention;

FIG. 2 is a diagram which explains how to determine the driving stop point of a developing roller used in a method to control the driving of the developing roller according to an embodiment of the present invention;

FIG. 3 is a diagram which explains the determination of a driving stop point of the developing roller in FIG. 2 with reference to a virtual image; and

FIG. 4 is a block diagram of an image forming apparatus which explains how to control the driving of the developing roller according to an aspect of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

One feature of an embodiment of the present invention is that the driving (rotation) time of a developing roller is minimized, since the developing roller is driven only during the period of time during which an electrostatic latent image is developed. In order to accomplish this feature, an aspect of the invention involves determining the point of time at which the last portion of a virtual image in a memory reaches the developing roller to determine a driving stop point of the developing roller.

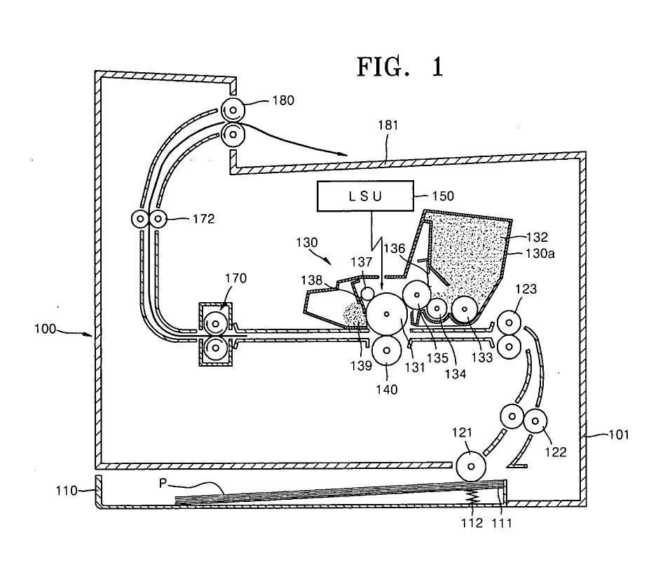

In order to fully explain this feature of the present invention, a schematic structure of an image forming apparatus used with an embodiment of the present invention will be described, and then a method to control the driving of a developing roller, located in the image forming apparatus, according to an embodiment of the present invention will be described. The method to control the driving of a developing roller according to an embodiment of the present invention can be applied to any image forming apparatus which uses an independently driven developing roller that rotates to develop an electrostatic latent image. In other words, the present invention is not limited to the structure of the image forming apparatus shown in FIG. 1.

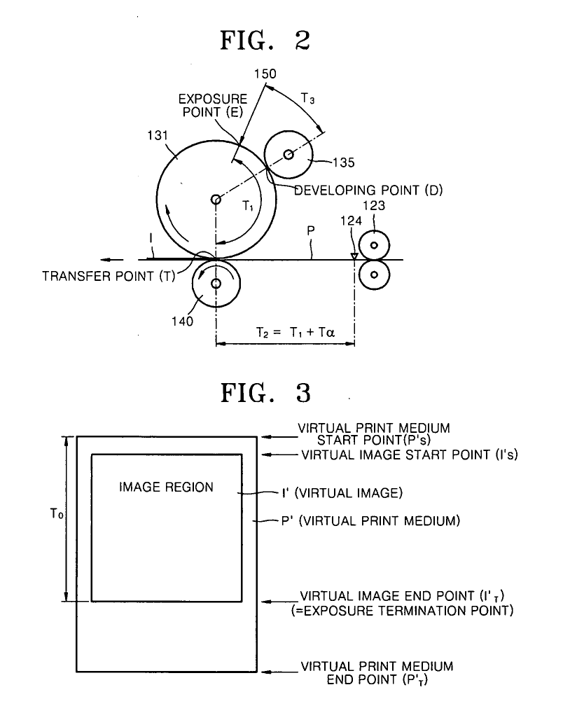

The schematic structure of the image forming apparatus of FIG. 1 is described below using FIG. 2. Referring to FIGS. 1 and 2, an image forming apparatus 100 includes a print medium cassette 110 with a print medium-loading tray 111. The print medium-loading tray 111 is attachably and detachably installed under a main body 101 of the image forming apparatus 100. A spring 112 applies an elastic force upward to the bottom of the print medium-loading tray 111. A number of print media P (such as paper, transparencies, etc.) are loaded into the print medium-loading tray 111. A pickup roller 121 picks up the loaded print media individually (one by one). The pickup roller 121 is disposed at an upper position of the print medium cassette 110, as shown in FIG. 1. The sheets of print media P picked up by the pickup roller 121 are moved into the main body 101. While shown in the context of a cassette or tray, it is understood that the print media can be otherwise delivered into the apparatus 100.

A developing unit 130, a transfer roller 140, a fixing unit 170, and a print medium-discharging unit 180 are each positioned along a print medium feed path. The pickup roller 121 picks up the print media P. A feeding roller 122 feeds the print medium P picked up by the pickup roller 121 to the print medium feed path.

The developing unit 130 is detachably installed into the main body 101 and forms an image onto the print medium P. The developing unit 130 includes a photosensitive drum 131. An electrostatic latent image, corresponding to the image intended to be printed onto the print medium P, is formed on the surface of the photosensitive drum 131 by an exposure unit 150. The exposure unit 150 is preferably, although not necessarily, a laser scanning unit (LSU) installed so as to be partially exposed through a housing 130a and to contact the transfer roller 140. When the print medium P moves through a contact portion between the photosensitive drum 131 and the transfer roller 140, the photosensitive drum 131 and transfer roller 140 transfer the image onto the print medium P. While described as detachable, it is understood that the developing unit 130 need not be detachable in all aspects, such as where the toner container 132 is refillable.

The developing unit 130 includes a toner container 132 which stores toner, an agitation roller 133, a developing roller 135, and a supply roller 134. The agitation roller 133 is disposed near the bottom of the toner container 132 and agitates the toner contained in the toner container 132 to prevent the toner from hardening. The developing roller 135 contacts the photosensitive drum 131 and develops the electrostatic latent image, formed on the surface of the photosensitive drum 131 by the exposure unit 150, into a toner image by supplying toner to the electrostatic latent image formed on the surface of the photosensitive drum 131. The supply roller 134 supplies the toner loaded in the toner container 132 to the developing roller 135.

The developing unit 130 further includes a regulating blade 136, a charging roller 137 and a cleaning blade 138. While not required in all aspects, the regulating blade 136 is shown fixed onto the housing 130a and limits the thickness of the toner supplied to the surface of the developing roller 135 by the supply roller 134. The charging roller 137 charges the surface of the photosensitive drum 131 to a predetermined electric potential. The cleaning blade 138 removes waste toner which is not transferred from the surface of the photosensitive drum 131 to the print medium P during printing operations. The waste toner scraped off by the cleaning blade 138 is stored in a waste toner storage area 139 and is collected by a collecting device (not shown). Monochromatic toner can be re-used after it is collected in the waste toner storage area 139. However, polychromatic waste toner cannot be reused, because the different colors in the polychromatic waste toner mix together in the waste toner storage area 139. It is understood that the elements of the developing unit 130 can be otherwise arranged and/or combined in other aspects of the invention.

The transfer roller 140 faces the photosensitive drum 131 and transfers the toner image I, formed on the surface of the photosensitive drum 131, onto the print medium P. The transfer roller 140 transfers the toner image I at a contact portion where the transfer roller 140 and the photosensitive drum 131 contact each other.

The fixing unit 170, which is disposed on the print medium feed path, fixes the toner image I to the print medium P by heat and pressure. A pair of discharge rollers 172 transfers the print medium P with the fixed image along the print medium feed path. The print medium-discharging unit 180 discharges the print medium P out of the main body 100a, at which point the print medium P is loaded onto a print medium-discharging tray 181.

A pair of registration rollers 123 aligns the print medium P, picked up from the cassette 110, as the print medium P moves towards the contact portion between the photosensitive drum 131 and the transfer roller 140. The pair of registration rollers 123 controls the speed of the print medium P as the print medium P passes over the transfer roller 140, to ensure that the toner image I is accurately transferred from the photosensitive drum 131 to the print medium P. Otherwise, the print medium P might move too fast or too slow across the contact portion, resulting in a poor quality transfer of the toner image I to the print medium P.

Reference number 124 denotes a registration sensor which senses the print medium P as the print medium P passes between the pair of registration rollers 123.

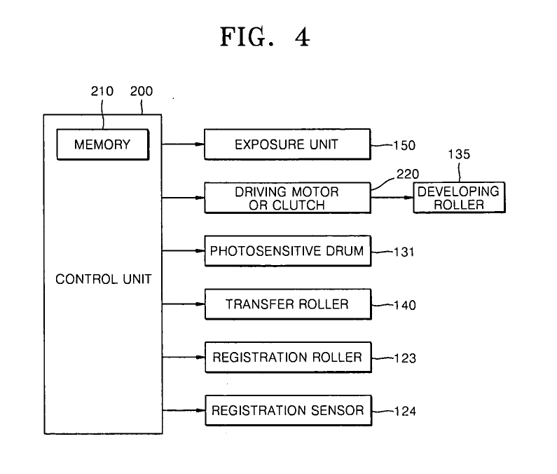

Referring to FIG. 4, the exposure unit 150, the photosensitive drum 131, the transfer roller 140, and the pair of registration rollers 123 are connected to and controlled by a control unit 200. The developing roller 135 is connected to a clutch 220, and the clutch 220 is connected to a driving motor or a main motor (not shown) so that the developing roller can operate independently from the main motor, the photosensitive drum 131, the pair of registration rollers 123, and other components of the image forming apparatus 100. Thus, as the control unit 200 drives the driving motor or the clutch 220, the developing roller 135 is driven when connected to the driving motor or the clutch 220. The control unit 200 includes a memory 210 which allows a user to store and update data required to control other constituent parts of the image forming apparatus 100. It is understood that the memory 210 may be any of various different types of memories.

A method to control the driving of the developing roller 135, according to an embodiment of the present invention, will be described below. Referring to FIG. 2, the transfer roller 140 is disposed below the photosensitive drum 131 to face the photosensitive drum 131, and the developing roller 135 is disposed on a right upper side of the photosensitive drum 131 to contact the photosensitive drum 131. It is understood that the transfer roller 140 and developing roller 135 may be located in positions other than those shown in FIG. 2.

An exposure point E, a developing point D, and a transfer point T are sequentially arranged in a rotational direction (i.e., clockwise direction of FIG. 2) of the photosensitive drum 131. At the exposure point E, a light beam emitted from the exposure unit 150 exposes an electrostatic latent image onto the surface of the photosensitive drum 131. The developing roller 135 develops the electrostatic latent image exposed on the surface of the photosensitive drum 131 into the toner image I at the developing point D, which is the point where the developing roller 135 contacts the photosensitive medium 131. The toner image I developed by the developing roller 135 is then transferred to the print medium P at the transfer point T, which is the point where the transfer roller 140 contacts the photosensitive drum 131. Thus, the image intended to be printed is formed by the sequential operations of emitting a light beam from the exposure unit 150 to expose an electrostatic latent image onto the surface of the photosensitive drum 131 at the exposure point E, developing the electrostatic latent image formed by the exposure unit 150 into the toner image I at the developing point D using the developing roller 135, and transferring the toner image I to the print medium P at the transfer point T using the transfer roller 140. It is understood that the timing of the sequence of these operations may vary, depending on the type of image forming apparatus used, the type of print medium P used, etc.

As shown in FIGS. 2 and 3, T₁ represents the time that the photosensitive drum 131 takes to rotate from the exposure point E to the transfer point T, T₃ represents the time during which the photosensitive drum 131 rotates from the exposure point E to the developing point D, and T₂ represents the time during which the print medium P is fed from the registration sensor 124 to the transfer point T. Ideally, T₁=T₂, so that the print medium P first arrives at the transfer point T at the exact moment that the toner image I formed on the photosensitive drum 131 also arrives at the transfer point T. However, during an actual printing operation, T₂=T₁+Tα, where Tα represents the time from when the print medium P is sensed by the registration sensor 124 to when the exposure unit 150 is operated. In other words, Tα represents the delay by the exposure unit 150 after the registration sensor 124 senses the print medium P.

Ideally, the point of time at which the driving (rotating) of the developing roller 135 stops is the point of time at which the electrostatic latent image, corresponding to the image intended to be printed onto the print medium P, has been completely developed. In other words, the driving of the developing roller 135 ideally stops when the last portion of the electrostatic latent image corresponding to the image intended to be printed passes the developing point D.

At the moment when the developing roller 135 stops driving, the electrostatic latent image has already been fully formed onto the exposure point E. More specifically, due to the time interval T₃ required for the photosensitive drum to rotate from the exposure point E to the developing point D, the last portion of the electrostatic latent image has been fully formed at the exposure point E for a length of time T₃ after the last portion of the electrostatic latent image has been exposed onto the exposure point E. Thus, the driving of the developing roller 135 ideally should stop at a length of time equivalent to T₃ after the last portion of the electrostatic latent image has been exposed onto the exposure point E, because the developing roller 135 does not need to be driven after the electrostatic latent image has been fully developed into the toner image I by the developing roller 135.

Referring to FIG. 3, when image data intended to be printed onto the print medium P is transmitted to the image forming apparatus 100, and in particular, to the control unit 200 (refer to FIG. 4), the control unit 200 virtually creates a virtual print medium P′ with a virtual image I′ in the memory 210. While shown as disposed within the control unit 200, it is understood that the memory 210 is not required to be physically stored within the control unit 200 and can be connected to the control unit 100 through a cable and/or wireless technology.

As shown in FIG. 3, the length of time required for the developing roller 135 to be driven from a virtual print medium start point P′ₛ to a virtual image end point I′_{T} is represented by T₀, wherein the virtual image end point I′_{T} corresponds to the same point of time at which the exposing of the electrostatic latent image onto the photosensitive drum 131 by the exposure unit 150 stops. Additionally, according to an aspect of the present invention, the driving of the developing roller 135 may be started and stopped multiple times during the printing of images onto a single print medium P, if multiple images are formed onto the same print medium P.

The length of time from the virtual print medium start point P′ₛ to the virtual image start point I′ₛ represents the length of time from when the leading edge of the print medium P is sensed by the registration sensor 124, to when an edge of the top margin (the first margin to reach the contact portion between the photosensitive drum 131 and the transfer roller 140) of the print medium P passes over the registration sensor 124 after a period of time Tα. This period of time may be determined by a user, for instance, when the user desires a bigger or smaller top margin.

Thus, the point of time T_{f} at which the driving of the developing roller 135 is terminated occurs after the point of time at which the driving of the exposure unit 150, which emits light to form an electrostatic latent image corresponding to the image that is intended to be printed, is terminated, and also occurs after the time required by the photosensitive drum 131 to rotate from the exposure point E to the developing point D.

In other words, the point of time T_{f} at which the driving of the developing roller 135 is terminated is calculated to be the sum of a first length of time T₃ that the photosensitive drum 131 takes to rotate from the exposure point E to the developing point D, and a second length of time T₀ from the virtual print medium start point P′ₛ to the virtual image end point I′_{T} (FIG. 3). This sum is expressed as T_{f}=T₀+T₃.

The time T₀ from the virtual print medium start point P′ₛ to the virtual image end point I′_{T} may vary according to an image intended to be printed on the print medium P. Additionally, the length of time T₃ which the photosensitive drum 131 takes to rotate from the exposure point E to the developing point D may vary according to the type of image forming apparatus used. However, regardless of the variations in the image intended to be printed on the print medium P or the type of image forming apparatus used, since the time T₀ and the time T₃ can be measured, the point of time T_{f} at which the driving of the developing roller 135 is terminated can be accurately determined by the control unit 200. Conversely, according to an aspect of the present invention, a driving start point of the developing roller 135 does not begin before the first portion of the electrostatic latent image formed on the photosensitive drum 131 reaches the developing point D (FIG. 2). However, this driving start point is not required in all aspects of the present invention.

In an embodiment of the present invention, when the power supplied to drive the developing roller 135 is cut off, the power supplied to the supply roller 134, the regulating blade 136, and the developing roller 135 is also cut off. In other words, the control unit 200 supplies power to the developing roller 135, the supply roller 134, and the regulating blade 136 only during the length of time when the developing roller 135 is driven. By minimizing the amount of time supplied to power the developing roller 135, the supply roller 134, and the regulating blade 136, aspects of the present invention make printing operations more efficient by reducing unnecessary power consumption, and also prolong the lifetime of the developing roller 135, the supply roller 134, and the regulating blade 136.

By using the method to control the driving of the developing roller according to an embodiment of the present invention, the driving of the developing roller is terminated after a period of time corresponding to the sum of an exposure time, during which an electrostatic image corresponding to an image intended to be printed is formed, and the length of time that the photosensitive drum 131 takes to rotate from an exposure point to a developing point. In other words, since the developing roller 135 is driven only during the length of time in which an electrostatic latent image is developed onto a print medium P, the lifetime of the developing roller 135 increases.

As described above, in a method to control the driving of the developing roller according to an embodiment of the present invention, the time during which the developing roller is driven is reduced. This reduction in driving time prevents toner from forming a thick film onto the surface of the developing roller, decreases wear on the developing roller and the regulating blade, and prolongs the lifetime of the developing unit.

While not required in all aspects, it is understood that aspects of the invention can be implemented using computer software stored on a medium for use by a computer and/or controller. Additionally, while described in terms of an image printing apparatus, aspects of the invention can be used in copiers, fax machines and/or combinations thereof.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method to control a developing roller which develops an image onto a print medium, the method comprising controlling a driving stop point of the developing roller,
wherein the driving stop point of the developing roller is determined by adding a print medium feed time from a virtual print medium start point to a virtual image end point and a time that a photosensitive drum takes to rotate from an exposure point to a developing point on the photosensitive drum, so that the developing roller is driven only when an electrostatic latent image is developed.

2. The method of claim 1, wherein the developing roller is driven independently by a clutch or motor.

3. The method of claim 2, wherein the virtual print medium start point corresponds to a point in time when the print medium first reaches the photosensitive drum.

4. The method of claim 1, wherein the virtual image end point represents a point of time at which an exposure process to form the electrostatic latent image onto the photosensitive drum, corresponding to the image, is terminated.

5. The method of claim 4, wherein the print medium feed time from the virtual print medium start point to the virtual image end point is calculated using a virtual print medium created in a memory of a control unit, wherein a virtual image on the virtual print medium corresponds to the image.

6. The method of claim 1, wherein the print medium feed time from the virtual print medium start point to the virtual image end point is calculated using a virtual print medium virtually created in a memory of a control unit, wherein a virtual image on the virtual print medium corresponds to the image.

7. The method of claim 1, wherein a time which a regulating blade and a supply roller operate is determined according to the driving stop point of the developing roller.

8. A method to drive a developing roller used in an image forming apparatus, comprising:
creating a virtual image corresponding to an image to be printed;
creating the virtual image onto a virtual print medium corresponding to a print medium;
creating non-image areas onto the virtual print medium corresponding to non-image areas of the image to be printed; and
driving the developing roller to print the image onto the print medium, wherein the developing roller is driven only for a length of time necessary to develop the virtual image, without developing the created non-image areas.

9. The method of claim 8, wherein the creating of the virtual image further comprises:
creating a virtual print medium start point and a virtual print medium end point which define the length of the virtual print medium; and
creating a virtual image start point and a virtual image end point which define the length of the virtual image.

10. The method of claim 9, wherein the developing roller is driven independently by a clutch or motor.

11. The method of claim 10, wherein the virtual image end point is a point of time at which an exposure process to form an electrostatic latent image onto the photosensitive drum, corresponding to the image to be developed, is terminated.

12. The method of claim 8, wherein a time which a regulating blade and a supply roller operate corresponds to the time the developing roller is driven.

13. A method to drive a developing roller used in an image forming apparatus, comprising:
emitting an electrostatic latent image onto an exposure point of a photosensitive drum as the photosensitive drum rotates the exposure point towards a developing point, the developing point being where the photosensitive drum contacts the developing roller, and the emission of the electrostatic latent image begins at a time T0; calculating a length of time T1 required to emit the electrostatic latent image onto the rotating photosensitive drum; and
driving the developing roller, wherein the driving begins at a length of time T2 required by the photosensitive drum to rotate from the exposure point to the developing point after T0, and the driving ends at a length of time T1 after T2.

14. The method of claim 13, wherein the calculating a length of time T1 comprises creating a virtual image corresponding to the image to be printed with a controller, and then storing the virtual image into a memory.

15. The method of claim 14, wherein undeveloped areas of the image to be printed are stored as undeveloped areas in the virtual image.

16. The method of claim 15, wherein the undeveloped areas of the image to be printed comprise margins.

17. The method of claim 15, wherein the developing roller is driven independently by a motor or clutch.

18. The method of claim 17, wherein a time which a regulating blade and a supply roller operate corresponds to the time the developing roller is driven.

19. An image forming apparatus, comprising:
a photosensitive drum on which an electrostatic latent image is exposed;
a developing roller which transfers toner onto the photosensitive drum to develop the electrostatic latent image into a toner image;
a transfer roller which transfers the toner image onto a print medium; and
a controller which creates a virtual image corresponding to the toner image and drives the developing roller for only a length of time necessary to develop the virtual image.

20. The image forming apparatus of claim 19, further comprising a motor or clutch to independently drive the developing roller.

21. The image forming apparatus of claim 20, wherein the controller further creates a virtual print medium, corresponding to the print medium, and the created virtual image is stored onto the created virtual print medium.

22. The image forming apparatus of claim 21, further comprising a memory to store the created virtual image and the created virtual print medium.

23. The image forming apparatus of claim 22, wherein a length of time which a regulating blade and a supply roller operate corresponds to the length of time necessary to develop the created virtual image.

24. A method to control a developing roller which develops an image onto a print medium, the method comprising:
determining an image size relative to a size of the print medium; and
driving a developing roller only for an extent of the image size, and not for a remainder of the print medium.

25. The method of claim 24, wherein the determining an image size relative to a size of the print medium comprises:
creating a virtual print medium corresponding to the size of the print medium;
creating a virtual image, corresponding to the image size, onto the created virtual print medium; and
determining a virtual image size relative to a virtual size of the created virtual print medium.

26. The method of claim 25, wherein the developing roller is independently driven by a motor or clutch.

27. The method of claim 26, wherein the created virtual print medium and created virtual image are stored in a memory.

28. The method of claim 27, wherein a time which a regulating blade and a supply roller operate corresponds to the time the developing roller is driven.
